(19) United States
(12) Patent Application Publication
(10) Pub. No.: US 2008/0157646 A1
(43) Pub. Date: Jul. 3, 2008

(54) APPARATUS OF LIGHT SOURCE

(75) Inventors: Shih-Pu Chen, Hsinchu City (TW); Jung-Yu Li, Taipei County (TW); Yi-Ping Lin, Changhua County (TW); Wei-Chih Lin, Taipei County (TW); Lian-Yi Cho, Miaoli County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/683,440

(22) Filed: Mar. 8, 2007

(30) Foreign Application Priority Data
Dec. 29, 2006 (TW) 95149963

(51) Int. Cl. H01J 1/00

(52) U.S. Cl. 313/483

(57) ABSTRACT

An apparatus of light source includes a cathode structure, an anode structure, a fluorescent layer, and a low-pressure gas layer. The fluorescent layer is located between the cathode structure and the anode structure. The low-pressure gas layer is filled between the cathode structure and the anode structure, and has the function of electric conduction. The low-pressure gas layer has an electron mean free path, allowing most of electrons to directly impact the fluorescent layer under an operation voltage.

### CROSS-REFERENCE TO RELATED APPLICATION

This application claims the priority benefit of Taiwan application serial no. 95149963, filed Dec. 29, 2006. All disclosure of the Taiwan application is incorporated herein by reference.

### BACKGROUND OF THE INVENTION

1. Field of the Invention

The present invention relates to an apparatus of light source. More particularly, the present invention relates to an apparatus of flat light source, for example, an apparatus of flat light source capable of generating a desired light.

2. Description of Related Art

Apparatuses of light source are widely used in daily life. The conventional apparatus of light source, such as a bulb, generates a visible light source through a filament, resulting in high temperature after being powered on. The light source of such a bulb is substantially a point light source. A tubular light source is then developed. Via a long-time development and variation, an apparatus of flat light source is also provided, such as the one widely used on a panel display.

There are many mechanisms for generating a light source. FIG. 1 is a schematic sectional view of the mechanism of a conventional apparatus of flat light source. Referring to FIG. 1, this light-emitting mechanism uses two electrode structures 100, 102 connected with a power source 106 to generate an electric field under an operation voltage, and uses a gas discharge, also referred to as plasma discharge to ionize gas 104 into electrons 110. The electrons 110 are accelerated by the electric field, and impact fluorescent layers 108a, 108b, 108c corresponding to different colors, such as red, green, blue fluorescent layers on the electrode structure 102. A visible light 112 is generated and emitted due to the effect of the fluorescent layers. Herein, as the electrode structure 100 is a light exit side, a light-transmissive material is generally employed, for example, composed of a glass substrate and an Indium-Tin Oxide (ITO) transparent conductive layer.

Another mechanism for generating light source is a field emission mechanism, as shown in FIG. 2. FIG. 2 is a schematic sectional view of a mechanism of another conventional apparatus of flat light source. A cathode structure layer 122 is disposed on a glass substrate 120. A plurality of conical conductors 124 is disposed on the cathode structure layer 122. A gate layer 126 is disposed on the conical conductors 124. A plurality of holes corresponding to the conical conductors 124 is arranged in the gate layer 126. In another anode structure layer 128, a transparent anode layer is disposed on a glass substrate. Furthermore, a fluorescent layer 130 is disposed on the anode structure layer 128. Electrons 132 escape from the tip of the conical conductors 124 under a high electric field between the cathode and the anode, accelerated by the electric field, and then impact the fluorescent layer 130 to emit a visible light.

The two conventional light-emitting mechanisms have their own advantages and disadvantages. The gas discharge mechanism is easy to realize and has a simple structure, but the plasma is required to be generated in the processes, and thus it is power consuming. The light source of the field emission is one of cold light sources, on a basis similar to a cathode ray tube (CRT). The electrons directly impact the fluorescent powder in a high-speed vacuum to emit a visible light. This light source of field emission is advantageous in high luminance and power saving, and also is easy to be fabricated into a flat structure, but a uniform emission material must be grown or coated on the cathode. For example, a spindle structure must be formed or a nanocarbon tube must be used. A microstructure with a large aspect ratio is used to enable the electrons to overcome the work function of the cathode to escape from the cathode into the vacuum space. In such a manner, it is difficult to uniformly form a large area cathode structure. Furthermore, the distance between the cathode and anode in the field emission is required to be accurately controlled, and thus the requirements for spacer specification is very strict, and the vacuum package is also one of the problems.

### SUMMARY OF THE INVENTION

The present invention is directed to an apparatus of light source, which can be easily fabricated into a flat light source without requiring a very high degree of vacuum, and the fluorescent materials can be selected, for example, to generate ultraviolet light source, infrared light, visible light, and so on.

The present invention provides an apparatus of light source, which includes a cathode structure, an anode structure, a fluorescent layer, and a low-pressure gas layer. The fluorescent layer is located between the cathode structure and the anode structure. The low-pressure gas layer is filled between the cathode structure and the anode structure, and has a function of electric conduction. The low-pressure gas layer has an electron mean free path, allowing most of electrons to directly impact the fluorescent layer under an operation voltage.

In order to the make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic sectional view of the mechanism of a conventional apparatus of flat light source.

FIG. 2 is a schematic sectional view of the mechanism of another conventional apparatus of flat light source.

FIG. 3 is a schematic sectional view of a light-emitting mechanism according to embodiments of the present invention.

FIG. 4 is a schematic sectional view of a flat light-emitting apparatus according to an embodiment of the present invention.

FIG. 5 is a schematic sectional view of a flat light-emitting apparatus according to another embodiment of the present invention.

FIG. 6 is a schematic sectional view of a flat light-emitting apparatus according to another embodiment of the present invention.

FIG. 7 is a schematic sectional view of a flat light-emitting apparatus according to another embodiment of the present invention.

FIG. 8 is a schematic sectional view of a flat light-emitting apparatus according to another embodiment of the present invention.

FIG. 9 is a schematic sectional view of a flat light-emitting apparatus according to another embodiment of the present invention.

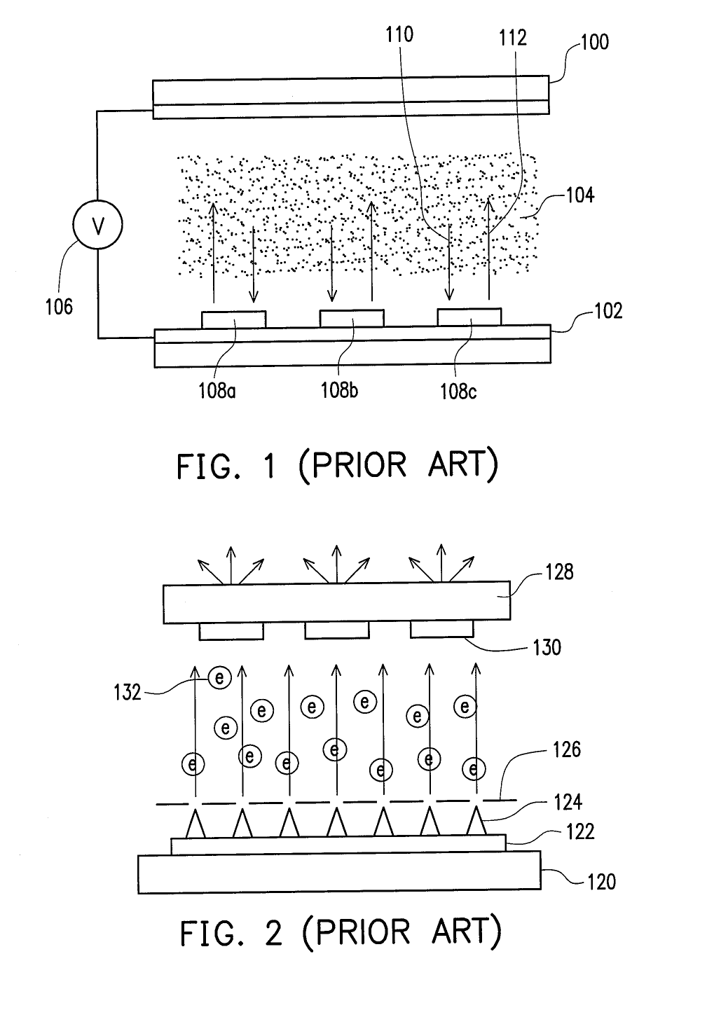

### DESCRIPTION OF EMBODIMENTS

The present invention provides an apparatus of light source, which utilizes a basic mechanism of gas discharge, and can achieve a field emission effect by controlling the vacuum degree of the gas. Thus, the apparatus of light source of the present invention can be easily fabricated into a uniform flat light source. Fluorescent materials can further be selected, for example, to generate a flat ultraviolet light source or other visible light, infrared light, and so on.

The apparatus of light source provided by the present invention utilizes the gas conduction characteristic to lead out a sufficient amount of electrons from the cathode. These electrons fly in a thin gas. As the electron mean free path in the thin gas is long, a sufficient amount of electrons will still directly impact, for example, the fluorescent powder material on the anode, so as to emit light. This fluorescent powder would be excited by electrons to emit light. If an ultraviolet light is required, the element proportion of the fluorescent powder emitting ultraviolet light can be adjusted, so as to emit light with a wavelength of 100 nm to 400 nm. Further, a voltage variation can be used to control the light-emitting intensity. The apparatus of light source of the present invention can at least achieve the advantages of low cost, uniform emitted lights, and simple structure.

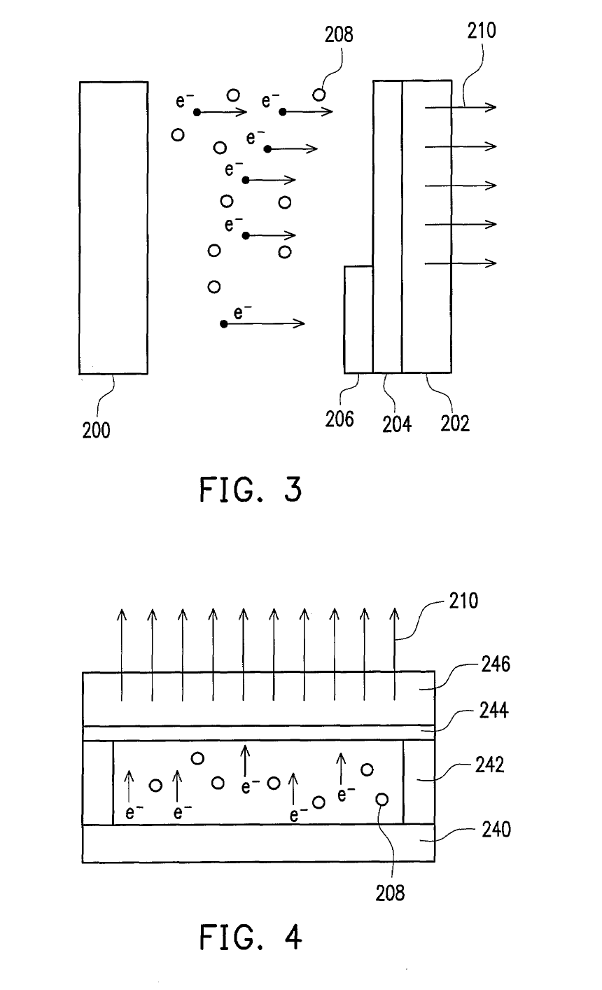

Some examples will be listed below, to illustrate the features of the present invention by way of example, but the present invention is not limited to these listed embodiments. FIG. 3 is a schematic sectional view of a light-emitting mechanism according to embodiments of the present invention. Referring to FIG. 3, an embodiment of the light-emitting apparatus includes a cathode structure layer 200 and an anode structure layer 202. Herein, the cathode structure layer 200 and the anode structure layer 202, for example, can substantially include a substrate and an electrode layer on the substrate, and its actual structure can be varied depending on an actual design, which is known to those of ordinary skill in the art and will not be further described herein. A fluorescent layer 204 is disposed between the cathode structure layer 200 and the anode structure layer 202, for example, generally disposed on the anode structure layer 202. In addition, a transparent layer 206 such as quartz or glass can also be disposed to define a light-emitting region. A low-pressure gas 208 is filled between the cathode structure layer 200 and the anode structure layer 202, wherein the gas is, for example, in a range of 1×10⁻² to 1×10⁻³ torr, such that the electron mean free path is greater than about 5 mm. Herein, the gas is enclosed in a space, which can be achieved by the ordinary conventional art, and the details will not be described here. Further, output and input components relating to the voltage are also achieved by using the ordinary conventional art, and will not be described in detail.

It should be noted that the filled gas is used for conduction, and thus the selected gas is preferably a gas easy to be ionized and conducted, but other gases can also be used. The gas in use is atmospheric air, He, Ne, Ar, Kr, Xe, H₂, CO₂, or the like. As the filled gas is in medium vacuum, the electron mean free path is still large enough to cause a sufficient amount of electrons to be accelerated by the electric field to sufficient energy to impact the material of the fluorescent layer 204, so as to emit a desired light.

In another word, a gas discharge mechanism is used in the present invention to uniformly generate a sufficient amount of electrons, and a field emission mechanism is also used to allow the ionized electrons to impact the fluorescent layer 204, so as to generate a desired light. The wavelength of the light varies in accordance with different materials of the fluorescent layer 204.

FIG. 4 is a schematic sectional view of a flat light-emitting apparatus according to an embodiment of the present invention. Referring to FIG. 4, for example, a flat light-emitting apparatus includes a cathode structure 240 and an anode structure 246. The fluorescent layer 244 is disposed between the cathode structure 240 and the anode structure 246, and preferably on one side of the anode structure 246. A spacer 242 isolates the cathode structure 240 from the anode structure 246 for a distance, and at the same time a space is enclosed for a low-pressure gas 208 to be filled in. With the aforementioned mechanism, when a proper work voltage is applied to the cathode structure 240 and the anode structure 246, a desired electric field is generated to accelerate the electrons to impact the fluorescent layer 244. Thus, the desired light source 210 is emitted from the anode structure 246. The anode structure 246 is, for example, light transmissive, and its anode conductive material is, for example, ITO, while the support substrate is, for example, quartz or glass. To prevent the leakage of the generated light, a surface of the cathode structure 240 can be disposed with a reflective layer, and thus the cathode structure 240 has a reflection function. For example, the cathode material of the cathode structure 240 can use metals with a reflection ability.

Also, the surface of the cathode structure may be dischargeable materials such as metal, nanocarbon material, and zinc oxide. The anode material of the anode structure is, for example, transparent conductive material, such as ITO, FTO, TCO, and other materials.

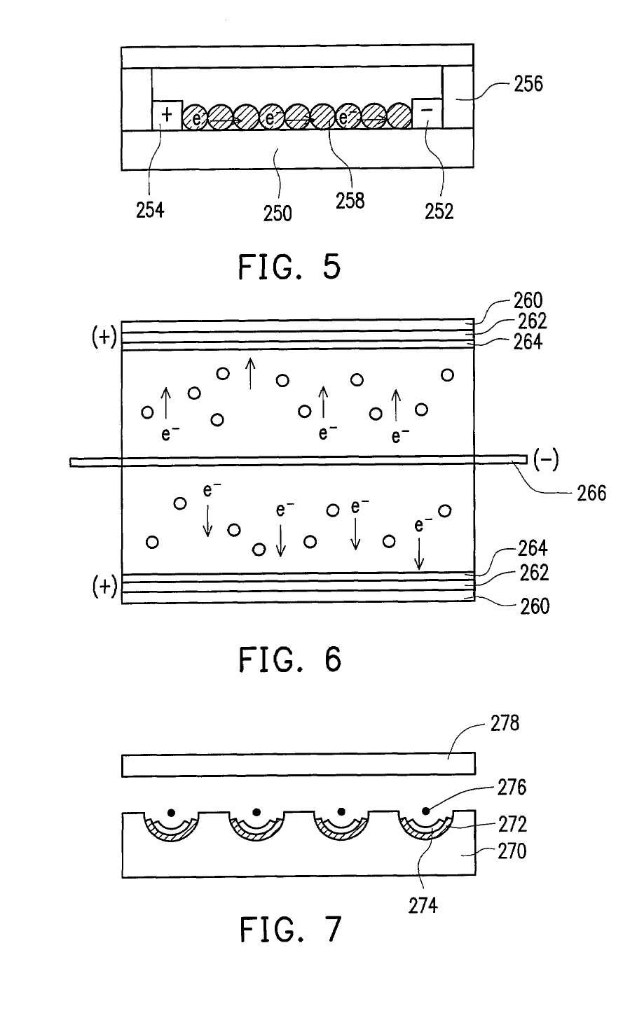

FIG. 5 is a schematic sectional view of a flat light-emitting apparatus according to another embodiment of the present invention. Referring to FIG. 5, in accordance with the same design principle, upper and lower substrates 250 and spacers 256 can compose an enclosed space for a desired low-pressure gas to be filled in. However, the anode structure 254 and the cathode structure 252 in this embodiment are both disposed on the lower substrate 250, so as to form a transversal electric field. In this structure, the fluorescent layer is also disposed on the lower substrate 250 between the anode structure 254 and the cathode structure 252. To enable the generated light to emit out towards a single side, for example, the lower substrate 250 may also be designed with a reflection function.

FIG. 6 is a schematic sectional view of a flat light-emitting apparatus according to another embodiment of the present invention. Referring to FIG. 6, in accordance with the same design principle, a tubular light-emitting apparatus can also be designed, such as a straight lamp tube or a bent lamp tube. The electrode conducting layer 262 and a fluorescent layer 264 included in the anode structure are disposed on a tube wall 260. The tube wall 260 will form an enclosed space for a low-pressure gas to be filled in. The cathode structure 266 is a linear structure, extending in accordance with the shape of the lamp tube. For example, when the section of the lamp tube is circular, the anode structure is disposed at the center of circle. The cathode structure is, for example, dischargeable materials such as metal, nanocarbon tube, nanocarbon wall, nono carbon material, and zinc oxide. The anode structure is, for example, transparent conductive material.

FIG. 7 is a schematic sectional view of a flat light-emitting apparatus according to another embodiment of the present invention. Referring to FIG. 7, the flat light-emitting apparatus includes a lower substrate 270 and an upper substrate 278 for composing an enclosed space. The design in this embodiment has a different arrangement of the cathode structure and the anode structure, but the basic mechanism is still unchanged. One or more grooves are disposed in the inner surface of the lower substrate 270, wherein the contour of the cross section of the grooves is curved, and preferably a circular arc. An anode structure layer 272 and a fluorescent layer 274 are disposed on the groove surface. The cathode structure 276 is, for example, a linear shape correspondingly located on the groove 272, for example, at the circle center of the circular arc. The material of the cathode structure 276 is, for example, the same as the cathode structure 266 in FIG. 6. The anode structure layer 272 also has a light reflecting function. As such, the flat light source can be composed of a plurality of anode structure layers 272 and cathode structures 276.

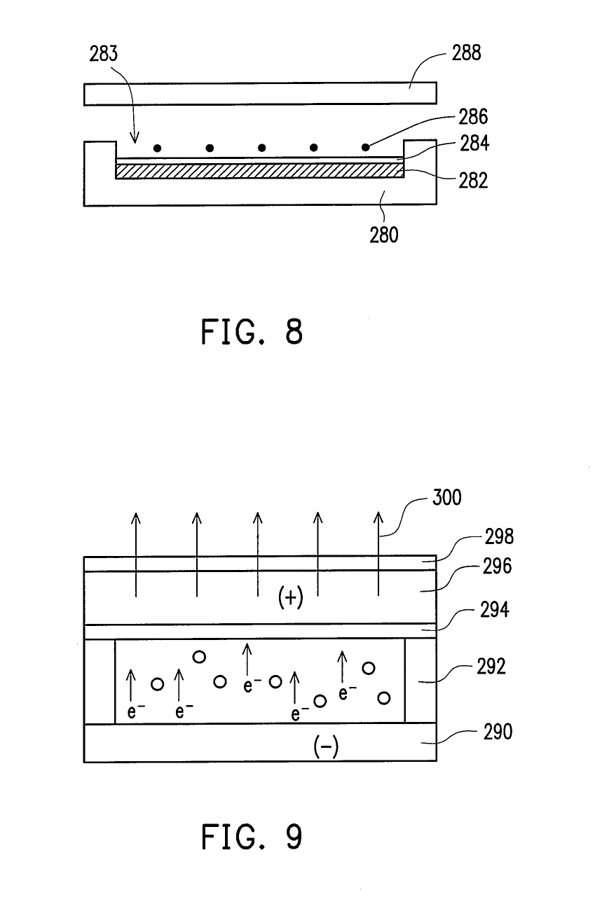

FIG. 8 is a schematic sectional view of a flat light-emitting apparatus according to another embodiment of the present invention. Referring to FIG. 8, a linear cathode structure 286 which is the same as the aforementioned description is also used in this embodiment. However, the anode structure layer 282 is planar and disposed on the substrate 280. Preferably, the anode structure layer 282 is in one recessed region 283 of the substrate 280. A fluorescent layer 284 is disposed on the anode structure layer 282. The aforementioned conductive gas is, for example, enclosed in a space by the substrate 288 and the substrate 280. The anode structure layer 282 of this embodiment composes a plane, while a plurality of cathode structures 286 are disposed above the anode structure layer 282 to compose a flat light source.

FIG. 9 is a schematic sectional view of a flat light-emitting apparatus according to another embodiment of the present invention. The light-emitting mechanism of the present embodiment is similar to the light-emitting mechanism described above, except that a photocatalyst is added. Referring to FIG. 9, the flat light-emitting apparatus includes a cathode structure 290 and an anode structure 296. A fluorescent layer 294 is disposed on the inner surface of the anode structure 296. Also, spacers 292 are disposed between the cathode structure 290 and the anode structure 296, and can further be, for example, disposed between the cathode structure 290 and the fluorescent layer 294 according to the design. Identical with FIG. 4, the cathode structure 290 is preferably a structure with a light reflection ability, for example, the electrode material itself is a metal with reflection ability, or if the substrate is light transmissive, a reflective layer is additionally disposed at the outer side of the cathode structure 290. By the use of spacers 292, the cathode structure 290 and the anode structure 296 are isolated for a distance, and compose an enclosed space for a low-pressure gas to be filled in. The anode structure 296 is, for example, a transparent electrode layer.

In this embodiment, a photocatalyst 298 is also disposed on the outer surface of the anode structure 296. The photocatalyst 298 converts the light 300 such as ultraviolet light emitted from the fluorescent layer 294 into a visible light. Therefore, the apparatus of light source can be directly used as an illuminating apparatus.

The apparatus of light source of the present invention can be used as a desired light source disposed in many other different apparatuses or systems, for example, the ultraviolet light used in exposure machine and washing process, components for biomedicine and environmental protection, and so on. The wavelength of the light source of the present invention can be in a range of infrared ray, visible light, or ultraviolet light.

The present invention emits light through the fluorescent mechanism to achieve a power saving effect and has at least some advantages. The structure of the present invention is simple, the cathode can be a simple flat structure and will not be specially treated, and it is not required to dispose other materials. The present invention does not require high vacuum package, thus simplifying the manufacturing process, and is benefit to large-scale production. The metal structure of the cathode can enhance reflectivity, thus enhancing luminance and improving light-emitting efficiency. The wavelength of the light emitted by the apparatus of light source is determined depending on the fluorescent material, so as to meet different wavelength ranges required by different designs. The apparatus of light source can be designed to be flat, linear or point light source, or the combination thereof. In accordance with a same mechanism, through a proper shape design, a planar or lamp tube structure can be designed. The fluorescent material is selected to emit light of various wavelengths, such as infrared ray, visible light, or ultraviolet light.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus of light source, comprising:
a cathode structure;
an anode structure;
a fluorescent layer, located between the cathode structure and the anode structure; and
a low-pressure gas layer, filled between the cathode structure and the anode structure, and having function of electric conduction,
wherein the low-pressure gas layer has an electron mean free path, allowing at least a sufficient amount of electrons to directly impact the fluorescent layer under an operation voltage.

2. The apparatus of light source as claimed in claim 1, wherein the air pressure of the low-pressure gas layer is in a range of 1×10⁻² to 1×10⁻³ torr.

3. The apparatus of light source as claimed in claim 1, further comprising a spacer for isolating the cathode structure from the anode structure, and constituting an enclosed space to compose the low-pressure gas layer.

4. The apparatus of light source as claimed in claim 1, wherein the cathode structure and the anode structure are plate structures.

5. The apparatus of light source as claimed in claim 4, wherein the fluorescent layer is located on a first surface of the anode structure.

6. The apparatus of light source as claimed in claim 5, further comprising a photocatalyst layer located on a second surface of the anode structure for receiving the light excited by the fluorescent layer.

7. The apparatus of light source as claimed in claim 1, wherein the anode structure is a transparent structure.

8. The apparatus of light source as claimed in claim 1, wherein the anode structure is long tube-shaped, the cathode structure is linear-shaped, located in an inner space of the anode structure and extending corresponding to the long tube shaped.

9. The apparatus of light source as claimed in claim 8, wherein the long tube shape is a straight tube shape or a bent tube shape.

10. The apparatus of light source as claimed in claim 1, wherein the cathode structure is at least a linear cathode, the anode structure is a metal flat plate with a reflection function, and the fluorescent layer is located on the anode structure.

11. The apparatus of light source as claimed in claim 10, further comprising a substrate structure having a recessed plane, and the anode structure is disposed on the recessed plane.

12. The apparatus of light source as claimed in claim 10, wherein the surface of the linear cathode is a dischargeable material.

13. The apparatus of light source as claimed in claim 1, further comprising a substrate structure having at least a curved surface groove, wherein the cathode structure is at least a linear cathode extending above the curved surface groove correspondingly, the anode structure has a reflection function and is located on the curved surface groove of the substrate structure, and the fluorescent layer is disposed on the anode structure.

14. The apparatus of light source as claimed in claim 13, wherein the linear cathode is a metal strip, a nanocarbon material is attached on the surface of the metal stripe.

15. The apparatus of light source as claimed in claim 13, wherein the linear cathode is approximately disposed at the curved surface focus above the curved surface groove.

16. The apparatus of light source as claimed in claim 1, further comprising a substrate, wherein the cathode structure and the anode structure are located on two sides of the substrate, and the fluorescent layer is located on the substrate and between the cathode structure and the anode structure.

17. The apparatus of light source as claimed in claim 1, wherein the cathode structure and the anode structure are two parallel metal strips, making the electrons to move transversely to impact the fluorescent material of the fluorescent layer.

18. The apparatus of light source as claimed in claim 1, wherein the fluorescent layer is impacted by the electrons to generate a desired light source.

19. The apparatus of light source as claimed in claim 1, wherein a flat light source is formed by the cathode structure and the anode structure.

20. The apparatus of light source as claimed in claim 1, wherein the electrons are led out from the cathode structure by means of gas conduction by the low-pressure gas layer, and the electrons are accelerated by an electric field to impact the fluorescent layer to generate light.
